(19) United States
(12) Patent Application Publication
(10) Pub. No.: US 2006/0084441 A1
(43) Pub. Date: Apr. 20, 2006

(54) Wireless communication method and system for restoring services previously provided by a disabled cell

(75) Inventor: Martin J. Dowling, Plymouth Meeting, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/018,809

(22) Filed: Dec. 20, 2004

Related U.S. Application Data
(60) Provisional application No. 60/619,642, filed on Oct. 18, 2004.

(51) Int. Cl. H04Q 7/20

(52) U.S. Cl. 455/445

(57) ABSTRACT

A method and system for restoring services previously provided by a disabled cell. A wireless communication system includes a plurality of cells, and each cell includes a base station. The system detects the disabled cell, and selects at least two base stations included by two respective cells that neighbor the disabled cell. The selected base stations adjust the azimuth and elevation antenna radiation patterns of beams so as to reorient the beams to restore the services previously provided by the disabled cell.

### CROSS REFERENCE TO RELATED APPLICATION(S)

This application claims the benefit of U.S. Provisional Application No. 60/619,642, filed Oct. 18, 2004, which is incorporated by reference as if fully set forth.

### FIELD OF INVENTION

The present invention is related to a multi-cell wireless communication system. More particularly, the present invention is related to restoring services previously provided by a now-disabled cell.

### BACKGROUND

If a base station in a cell of a wireless communication system becomes disabled because of, for example, natural disaster, failure or a terrorist attack affecting the equipment, it is highly desirable to immediately continue operations in that cell. As 3G wireless communication systems become more widespread, the pressure to quickly restore operations in a down-cell (i.e., a cell in which the serving base station is disabled) becomes important.

Adjustment of cell capacity differs from adjustment in overall coverage of a system in that the loss of a cell is presumed to be a sudden occurrence. Unlike changes in overall coverage area for a cellular system, it is important that some degree of service be afforded in the area affected by an outage on an immediate basis. This is substantially different from the types of power and service adjustments made in order to fill gaps in service or extend service coverage on a long term basis. Moreover, if the cell coverage is lost due to an event related to an emergency situation, it becomes particularly important to provide service very quickly.

Another difference found in extending cell coverage as part of general planning as opposed to emergency coverage is that prior to catastrophic loss of a cell, the system is configured to provide optimum service with the lost cell included in the system. Once a cell is incapacitated, bordering cells would be dramatically affected by any mitigation effort. As a result, quality of service (QoS) would be compromised. Such effects can also affect cells in the second and third tier around the damaged cell.

The operator of the wireless communication system has to provide emergency coverage since the government may require operators to provide such coverage, and users in a down-cell need coverage in order to obtain emergency services. While temporary and, finally, permanent base stations will eventually replace the disabled one, it is vitally needed in the short term to provide immediate coverage of the down-cell by its neighbors.

There are efforts underway to enhance communications between first responders in emergencies. One example is MESA, a project of the International Public Safety Mobile Broadband Standardization Partnership, sponsored by TIA and ETSI. It is designed to “revolutionize the efficiency of first responders and rescue squads at the scene of a disaster.” For example, radios in emergency vehicles would automatically build up an ad-hoc network as they approach the scene.

As another example, ETSI has made public a special report SR 002 108 on emergency call handling, which covers such topics as charge exemption and speech quality for emergency calls, and means for automatically locating an emergency caller (ordinary citizen). If that caller's cell is down, his main concern is simply getting his call through—which probably won't happen unless his PLMN operator has made provision for such an emergency.

Satellite systems are sometimes used to provide a temporary solution. However, satellite systems have limited bandwidth and require a clear overhead, and do not work well inside a building or car. Furthermore, the average person caught in a disaster has a cellular phone, not a satellite phone.

The value in enabling citizens to communicate while trapped in an emergency situation extends far beyond their immediate benefit. Such folks with working cell phones can provide much critical information to rescue workers, informing them where to go, where to avoid (because of danger), a description of the environment (power outage, presence of gas, weak ceilings), the cause of the disaster, extent and nature of injuries, and so forth. This helps the first responders to prepare with the correct equipment, and approach the scene safely.

Therefore, providing a method to immediately re-establish cellular connectivity in a disaster scene is equally important as improving communications among rescue workers and their vehicles. Considerable effort has gone into the latter approach. This invention solves the former problem, of immediately re-establishing cellular service in a disaster scene when the serving base station has been disabled.

### SUMMARY

In accordance with the present invention, a wireless communication system including a plurality of cells is provided with a capability of restoring services previously provided by a disabled one of the cells. A set of neighboring cells are selected as capable of communicating within a region of the disabled cell. A subset of the set of neighboring cells is then selected such that an increase in coverage of the transceivers in the subset provides significant communication coverage of the disabled cell, while reducing interference of sectors in the neighboring cells below interference which would otherwise be caused by using transceivers on all of the neighboring cells to provide communication coverage.

In one configuration, a subset of base stations is selected in order to provide coverage for the disabled cell based on load, capability and intercell interference. The cells of the selected subset have their azimuth and elevation antenna radiation patterns adjusted in order to cover the down-cell. Service data rates are intentionally downgraded and handover and admission thresholds are adjusted in order to create a migration of load.

### BRIEF DESCRIPTION OF THE DRAWINGS

FIG. 1 is a diagram of cells with cell names.

FIG. 2 illustrates the case where one cell covers a disabled cell.

FIGS. 3(a) and 3(b) show an increase in radius of cell coverage.

FIGS. 4(a) and 4(b) are diagrams of cells showing alternative embodiments for covering a disabled cell.

FIG. 5 is a diagram of a cell showing a configuration in which opposed transmitters provide cell coverage for covering a disabled cell.

FIG. 6 is a diagram showing an embodiment of a radio network configuration.

FIG. 7 is a flow chart of the procedure used to re-establish communication in a disabled cell.

FIG. 8 is a flow chart of an alternate procedure used to re-establish service in a disabled cell.

### DETAILED DESCRIPTION OF THE PREFERRED EMBODIMENTS

Hereafter, the terminology “wireless transmit/receive unit” (WTRU) includes but is not limited to a user equipment, a mobile station, a fixed or mobile subscriber unit, a pager, or any other type of device capable of operating in a wireless environment. When referred to hereafter, the terminology “base station” includes but is not limited to a Node B, a site controller, an access point or any other type of interfacing device in a wireless environment.

The present invention proposes a method by which a public land mobile network (PLMN) can restore services to a down-cell by utilizing capabilities of neighboring base stations. The present invention achieves this purpose by coordinating the activities of neighboring cells, adjusting selected power levels, redirecting antenna radiation patterns, degrading data rates, and redistributing load among neighboring cells.

According to an embodiment of the invention, a cellular wireless communication system adapts to an event in which one or more cells fail(s), in order to provide communication coverage during a possible emergency situation. The missing cell previously existed within the system prior to catastrophic loss of the cell and the system was in equilibrium and presumably functioning well with all cells in place prior to the loss.

Once a cell is incapacitated, according to the present invention several of the bordering cells are dramatically affected in order to obtain coverage over the missing cell. Changes include data rates being drastically lowered, QoS being compromised, and other services reduced. Such measures would not be accepted by subscribers in adjoining cells in a normal situation. These measures would be more acceptable in an emergency situation and on a short-term basis, until a true temporary or permanent base station could be installed.

In contrast with an attempt at extending a service area in routine operation, considerations are given to providing a reasonable QoS in surrounding areas. This precludes taking measures which have substantial impact on areas as a matter of routine service extension.

If neighboring cells are used to provide service to a failed cell, the bordering cells are substantially affected by interference. In addition, the change in service also affects cells in the second and third tier around the damaged cell. Therefore, a ripple effect occurs through the system within the general area near the failed cell. As the immediate neighbors pick up the load that would have been carried by the missing cell, their neighbors have to pick up some of their load that they are now neglecting. For example, if the immediately neighboring base stations have the ability to narrow (in azimuth) and raise (in elevation) their radiation pattern, this means service is being redirected toward the down cell and away from their own WTRUs. Their neighboring sectors and cell will pick up this load.

Another example occurs if a public land mobile network (PLMN) instructs base stations that a high handover threshold is to be used for WTRUs on the borderline of a more central cell (in other words, a cell closer to the damaged cell; not necessarily the particular damaged cell). This makes it more difficult for WTRUs to be accepted into cells closer to the disabled cell. Similarly, the handover threshold is reduced for WTRUs on the boundary with more distant cells (distant from the damaged cell). This makes it easier for WTRUs to switch to cells farther from the disabled cells. This centrifugal migration of load away from the disabled cell helps the disabled cell, but burdens cells in the second and third tiers away from the damaged cell. In the short term, QoS will be reduced everywhere in the region a situation which would not be acceptable, except in an emergency scenario.

The benefits of the invention are that, in an emergency, there can be immediate restoration of voice and low rate data service in a cell that has a defunct base station. Further, the implementation of the invention does not require physical modifications, but simply utilizes whatever capabilities already exist in surrounding base stations. In a preferred embodiment, it is a software change affecting how an RRM responds to an emergency.

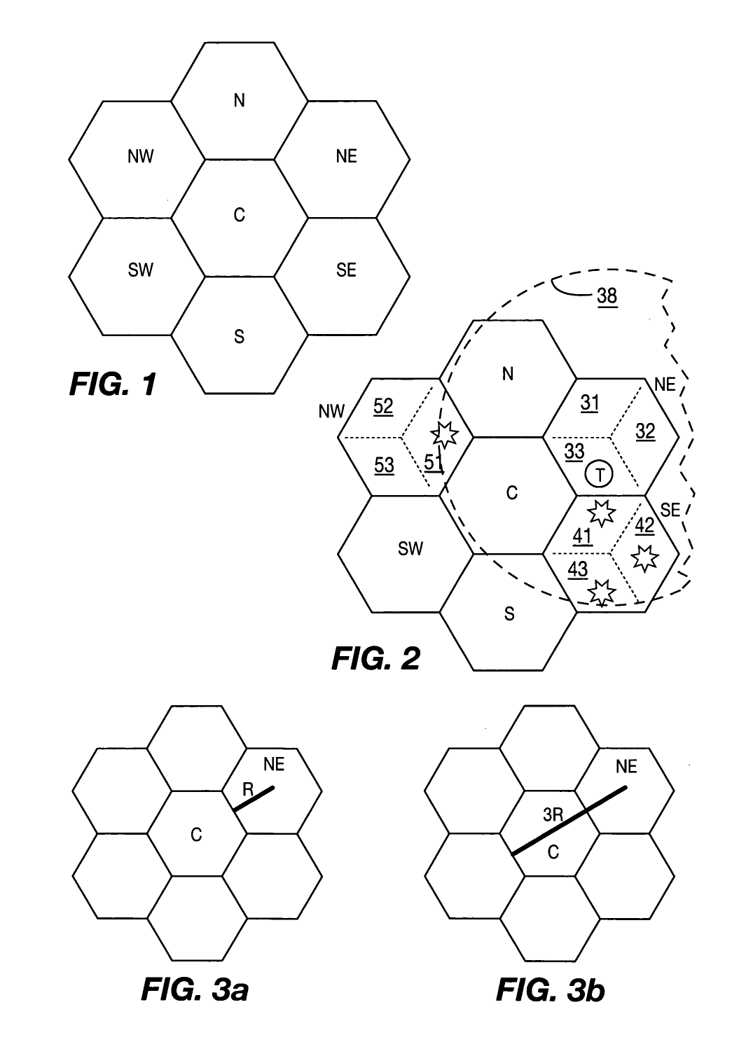

FIG. 1 shows cell naming convention in which C is a center cell and the remaining cells are named after points of a compass (N—north; NE—northeast; SE—southeast; S—south; SW—southwest; NW—northwest). Hereinafter, it is assumed that the center cell is the one that is disabled.

FIG. 2 shows an embodiment whereby only one neighboring base station covers a disabled cell while continuing operations in its own cell. In FIG. 2, a base station NE is covering a disabled cell C. Preferably, each cell is sectorized into a plurality of sectors, for example three sectors 31-33 as shown in the NE cell, three sectors 41-43 in the SE cell and three sectors 51-53 in the NW cell. It is understood that the physical arrangements of the cells will not typically be in neatly arrayed geometrical shapes; however coverage is often provided in a grid in which station locations are generally selected according to geometric factors. More significantly, loss of a transceiver at one location will generally result in a gap in the coverage area, with the gap surrounded by other cells.

Circle 38 shows the expanded cell coverage of the NE base station. It is likely that only one sector, depicted as sector 33, will take over the down-cell so the circle only applies in that 120° arc (this is indicated by the circle-T symbol in sector 33). The star symbol shows sectors 41-43 and 51 in which the NE cell will interfere with other non-disabled neighboring cells. NE sector 33 interferes with approximately four other sectors, three sectors in SE cell and half of sector 2 in NW cell.

In this example, interference is depicted as occurring with NW and SE but not N, S and SW. This is because NE sector 33 only covers an arc of 120 degrees, which does not coincide with the N, S and SW cell. Taking the example of the N cell, it can be seen that the top, horizontal, line of sector 33 (NE cell) is collinear with the southern boundary of the N cell.

The transmit power in NE sector 3 is increased considerably to cover the whole disabled cell C. In addition, the load in NE sector 3 increases fourfold because it now has to serve all three sectors in the disabled cell C as well as its own sector.

FIGS. 3(a) and 3(b) show the increase in cell or sector radius when one cell (NE in this example) covers for the disabled cell. Original NE Cell radius is R, but the radius with expanded coverage becomes 3R, at least as far as sector 33 is concerned. Using an exponent of three (3), the power drops off at the cell edge by 14.3 dB:

$${( \frac{3 R}{R} )}^{3} = 27 = 14.3 d B \qquad ( Equation 1 )$$

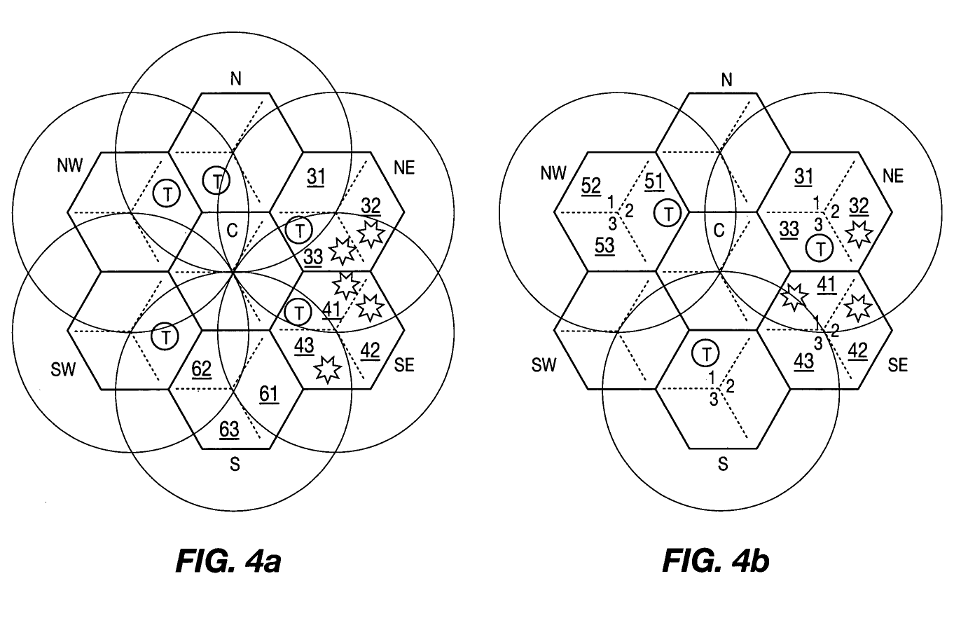

FIGS. 4(a) and 4(b) show embodiments in which multiple cells cover the disabled cell C. In FIG. 4(a), all six tier one neighbor cells cover the disabled cell C. The NE sector 3 interferes with 1½ sectors in the SE cell, and vice versa. (The half sectors are not separately depicted, but rather are depicted in the drawing as interference affecting the whole sector.) Since every cell interferes with 1½ sectors in one of its neighbors, altogether nine (9) sectors are exposed to increased interference in the embodiment of FIG. 4(a). In addition, there would be a large amount of interference in the disabled cell such that the quality of service in the disabled cell would degrade. This is significant because signal coverage to the disabled cell is provided by neighboring cells, which are at a less than optimum range.

In FIG. 4(b), three sectors participate in helping the down-cell (the center cell). NE sector 33 interferes with 1½ sectors 41, 42 in the SE cell and, in general, each of the three participating base stations interferes with 1½ sectors in its clockwise neighbor. The total interference in the three active base station case is 4½ sectors. Therefore, the mutual interference and handoff problem within the disabled cell is less than the embodiment of FIG. 4(a).

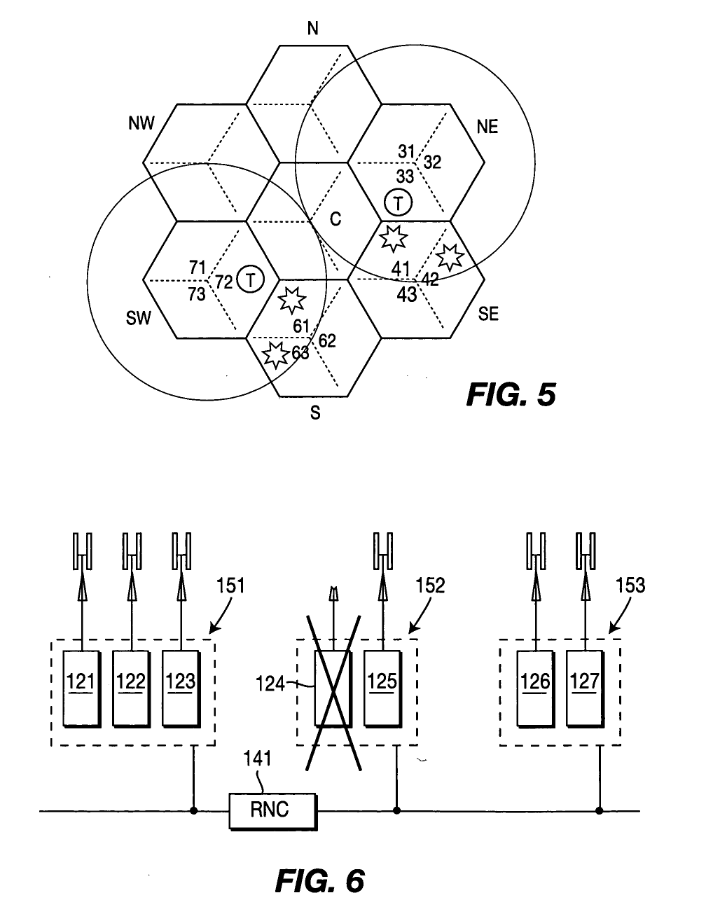

FIG. 5 is an embodiment in which two diametrically opposed base stations, transmitting from sectors 33 and 72, cover the disabled cell. The two cells (that is, one pair of opposed cells out of three pairs) are selected in accordance with load and capacity. In this case, the NE base station affects cell SE sector 41 and half of sector 42. Likewise, the SW base station interferes with cell S sector 61 and half of sector 63. The total interference in this case is three sectors. There is very little mutual interference between the two base stations within the disabled cell. In terms of interference, this embodiment is preferred. The number of handoffs is also reduced in accordance with this embodiment, and thereby increases capacity.

It is noted that other factors enter into mitigation of interference. For example, if the number of users in a particular sector of a cell is small, then the interference affecting that sector may be less significant. This can be predetermined or determined in real time in accordance with actual usage. By way of example, the number of communication requests in a particular cell may be used to weight the interference to that sector.

As mentioned above with respect to FIG. 2, the potential problem for covering a disabled cell by neighboring cell(s) is the transmit power. In the embodiments of FIGS. 4(a), 4(b) and 5, the extended radius becomes 2R. Assuming an exponent of 3, the power drop off at cell edge is 9 dB:

$${( \frac{2 R}{R} )}^{3} = 8 = 9 d B \qquad ( Equation 2 )$$

The present invention provides a means for compensating for this 9 dB loss.

The specific pair of neighbor base stations should be selected on capability, such as the ability to redirect the antenna radiation pattern, and available capacity.

FIG. 6 is a diagram showing a cellular network configured for implementation of the invention in the environments described in connection with FIGS. 4-5. A plurality of transmitting stations 121-127 may include one disabled station 124. These may be controlled by a radio network controller (RNC) 141 and by local controllers such as Node B controllers 151-153. The RNC 141, on sensing the loss of a station 124 implements a strategy for covering the station's cell by use of one or more of the neighboring stations 121-123 and 125-127.

To accomplish the task of extending the coverage of neighboring base stations into the disabled cell, both azimuth and elevation adjustments in the radiation patterns may be utilized. Azimuth adjustments consist of reorienting the beam directly toward the down cell, and narrowing the pattern, for example to 60°. A reduction of the radiation pattern from the usual 120° to 60° produces a gain of 3 dB. Lessening the down-tilt of the antenna would also help if this adjustment is available. Depending on how close the far end of the disabled cell is to the first elevation null, the gain could be as much as 3 dB, although a 1 or 2 dB gain is more likely in practice. The actual gain depends on the geometry.

Reducing data rates has a very significant effect on the gain and interference. In a 3G system, there is a mix of services including voice and data transfer. As an example, assuming that half of the cell's load is 12.2 kbps voice service and the other half 64 kbps data service, the network can reduce voice service to half rate (from 12.2 kbps to AMR 5.9 or 6.7 kbps) and reduce the data service to similar levels (say for example, to 6.4 kbps). Because lower data rates require lower power, the result is a gain of 6≈8 dB.

This decrease in data rates must be applied to all cells in the area—not only the first tier cells around the disabled cell, but even into the second tier—in order to keep the interference low enough. The decrease in data rates must be done gracefully and orderly, that is, gradually over a period of one or two minutes. This insures a continuation of present services while preparing to acquire new WTRUs.

In order to accommodate the extension of service to the disabled cell, data rates at the cell sectors used to cover the disabled cell are reduced. The degrading data rates are intended to increase capacity in terms of number of users and required power levels. The extension of coverage by the neighboring cells is further enhanced by shifting some load to a second tier of neighboring cells, more distant from the disabled cell. In order to accomplish this, the thresholds used to determine which cell is used for communicating with a particular WTRU are adjusted. This gives preference to a connection with a second tier cell and thereby may reduce the load on the first tier cell.

Redistribution of load by adjustment of handover parameters is another embodiment. The network manipulates handover and admission controls so that the load flees from the disabled cell. The PLMN instructs base stations that a high handover threshold is to be used for WTRUs on the borderline of a more central cell. This makes it more difficult for WTRUs to be accepted into cells closer to the disabled cell. Similarly, the threshold is reduced for WTRUs on the boundary with more distal cells. This makes it easier for WTRUs to switch to cells farther from the disabled cells. This centrifugal migration of load away from the disabled cell helps reduce interference and increase capacity where it is needed in the vicinity of the down cell.

Adjusting power, modulation and coding is another scheme. System parameters such as power, modulation and coding can be adjusted as needed to achieve a balance of load throughout the cell cluster, including the disabled cell.

In an emergency, neighboring base stations can cover for a disabled station by means of:
1) Selecting one or more base stations, preferably two diametrically opposed base stations, based on load and capability;
2) Redirecting the azimuth and elevation antenna radiation pattern of the selected neighbor base stations to cover the down-cell;
3) Mandating a reduction of all service data rates to an emergency minimum, such as 6 kbps per user; and
4) Adjusting handover and admission thresholds to create a centrifugal migration of load.

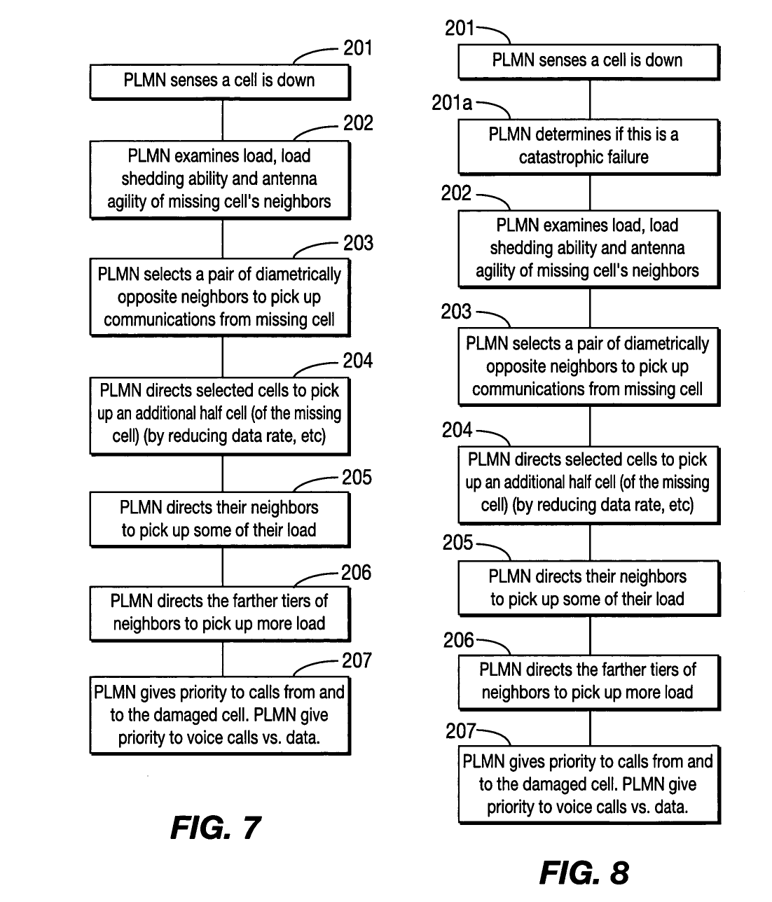

FIG. 7 illustrates the method of the invention. In the first step (step 201) the PLMN determines that a cell is down. Assuming the base station has been physically damaged, all communications, attempts at synchronization, measurement requests, in short all signaling and control messaging attempts toward the disabled base station will indicate “error” or “failure” to the requesting RNC. If the damaged cell is in the middle of the RNC's physical area of responsibility, the RNC can handle the failure by its own means. If the damaged cell is near its boundary, the RNC will need to solicit the cooperation of neighboring RNCs, utilize the PLMN's higher layers if need be to accomplish this.

In the second step, 202, FIG. 7 further shows that the PLMN (or RNC) examines the parameters of the surrounding cells preliminary to selecting the best pair for picking up the connections of the damaged cell. One factor is the present load of surrounding cells. For example, if one pair of diametrically opposite cells has a significantly lower combined load than the other pairs, then this is a favorable indicator for selecting this pair. Another factor is load shedding ability. This relates to the cells that are neighbors (in the second and third tiers around the damaged cell) to the candidate pair. How easily can the second and third pair absorb the candidate's load when the candidates pick up the down cell's load? Another factor is the antenna agility of the candidate pair. Perhaps one pair of opposed cells has beam forming ability, or the ability to narrow their sectors' azimuthal radiation pattern from 120 to 60 degrees of arc. This would be an important advantage in covering for the missing cell.

Based on these and similar criteria, the RNC or PLMN selects the optimum pair of diametrically opposite neighbors to cover for the communications of the damaged base station, (step 203). The use of diametrically opposite neighbors is one technique, but not the only technique, for selecting optimum coverage. More generally, a predetermination of an optimum coverage configuration is often advantageous; however optimum coverage may be determined in any other convenient manner and may be determined by the RNC or PLMN either “on the fly” or prior to a need for coverage (step 201).

In (step 204), the PLMN or RNC directs the diametrically opposite cells it has selected to pick up an additional half of the missing cell. It instructs the selected cells to reduce data rate of all connections to a base level such as 6.4 kbps, tune its antenna pattern by altering the electronic downtilt (if this or other adjustments are available), lower the handover threshold, give priority to voice calls, and perform all such adjustments that will enable the selected cells to cover the down cell's communications.

It would not be likely that the two selected cells would be able to take on the new cells by themselves. The RNC instructs (step 205) the neighbors of the selected cells to shed load away from the disaster in order to pick up some of the load of the selected diametrically opposite cells.

The load shedding does not stop even at the second tier. The third tier, and possibly even further tiers, must also shed load as they pick up load from cells closer to the disaster (step 206). They do this by reducing the rate of all their connections, by lowering the handover thresholds for sectors and cells away from the disaster to encourage load to move away from the disaster.

Looking at the large picture, these adjustments create a centrifugal migration of load away from the disabled cell. This helps reduce interference and increase capacity where it is needed—in the vicinity of the down cell.

Finally, (step 207), the RNC or PLMN instructs the base stations in the region of the disaster to give priority to calls from and to the damaged cell, and to give priority to voice calls as opposed to data transmissions. This will not affect rescue worker communications as they use different frequencies and communication systems.

FIG. 8 shows an alternate embodiment in which a new step (step 201a) is added after step 201. In this embodiment, the RNC or PLMN determines if this is a catastrophic failure, meaning that it is not merely a temporary power failure or bug at the base station. This is determined by the volume of attempted calls to that cell and the volume of attempted calls in the vicinity of that cell. In a non-catastrophic scenario the volume of calls will increase only slightly whereas in a disaster, the volume will increase dramatically. Furthermore, in a PLMN that has planned for such emergencies, human operators will quickly become aware of the nature of the emergency and trigger a system response in accordance with the invention. Step 201a provides the PLMN with the option of responding with a full set of emergency adjustments only in the event of a true catastrophe.

The result of the described method is that voice communications will be largely restored IMMEDIATELY in the damaged cell, enabling civilians on the scene to help guide and warn first responders, as well as to assure their own family members that they are safe.

Although the features and elements of the present invention are described in the preferred embodiments in particular combinations, each feature or element can be used alone without the other features and elements of the preferred embodiments or in various combinations with or without other features and elements of the present invention.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. In a wireless communication system including a plurality of cells, each cell including a base station, a method of restoring services previously provided by a disabled one of the cells, the method comprising:
selecting a set of neighboring cells having transceivers capable of transmitting and receiving signals with a wireless transmit and receive unit (WTRU) located within a region of the disabled cell; and
selecting a subset of the set of neighboring cells such that an increase in coverage of the transceivers in the subset provides significant communication coverage of the disabled cell, while reducing interference of sectors in the neighboring cells below interference which would otherwise be caused by using transceivers on all of the neighboring cells to provide communication coverage.

2. The method of claim 1 comprising, upon selecting the subset, adjusting power, modulation and coding of the subset.

3. The method of claim 1 comprising, upon selecting the subset, adjusting power, modulation and coding of a plurality of the neighboring cells in a manner calculated to reduce required signal power for the restored services to the disabled one of the cells.

4. The method of claim 1 comprising, upon selecting the subset, adjusting power, modulation and coding of a plurality of the neighboring cells as needed to increase a balance of load throughout the plurality of cells, including the disabled cell.

5. The method of claim 4, further comprising adjusting connection thresholds of the neighboring cells with WTRUs so as to limit access to said neighboring cells in the event of connectivity of said WTRU with a further tier of adjacent cells.

6. The method of claim 1 comprising:
selecting a subset of one or more base stations to provide coverage for the disabled cell based on load, capability and intercell interference;
redirecting the azimuth and elevation antenna radiation pattern of the selected neighbor base stations to cover the down-cell;
reducing service data rates for a plurality of users in at least a plurality of the cells; and
adjusting handover and admission thresholds to create a migration of load.

7. The method of claim 6 comprising reducing service data rates by arbitrarily reducing service data rates to a predetermined rate.

8. The method of claim 6 comprising adjusting handover and admission thresholds to create a centrifugal migration of load.

9. The method of claim 6 comprising selecting the subset of the set of neighboring cells by using weighted interference values based on usage of the wireless network calculated in real time.

10. The method of claim 6 comprising selecting the subset of the set of neighboring cells by using weighted interference values based on predetermined values.

11. The method of claim 1 comprising:
selecting one or more base stations, with preference to two diametrically opposed base stations, based on load and capability;
redirecting the azimuth and elevation antenna radiation pattern of the selected neighbor base stations to cover the down-cell;
reducing service data rates for a plurality of users in at least a plurality of the cells; and
adjusting handover and admission thresholds to create a migration of load.

12. The method of claim 1 comprising:
selecting one or more base stations, with preference to a predetermined geometric relationship of base stations, based on load and capability;
redirecting the azimuth and elevation antenna radiation pattern of the selected neighbor base stations to cover the down-cell;
reducing service data rates for a plurality of users in at least a plurality of the cells; and
adjusting handover and admission thresholds to create a migration of load.

13. The method of claim 11 comprising adjusting handover and admission thresholds to create a centrifugal migration of load.

14. The method of claim 1 comprising selecting the subset of the set of neighboring cells by using weighted interference values based on usage of the wireless network calculated in real time.

15. The method of claim 1 comprising:
detecting the disabled cell;
selecting at least two base stations included by two respective cells that neighbor the disabled cell; and
adjusting the azimuth and elevation antenna radiation patterns of beams generated by each of the two base stations so as to reorient the beams to provide the services previously provided by the disabled cell.

16. A cellular telephone system configured to restore services previously provided by a disabled one of the cells according to the method of claim 1.

17. In a wireless communication system including a plurality of cells, each cell including a base station, a method of restoring services previously provided by a disabled one of the cells, the method comprising:
detecting the disabled cell;
selecting at least two base stations included by two respective cells that neighbor the disabled cell; and
adjusting the azimuth and elevation antenna radiation patterns of beams generated by each of the two base stations so as to reorient the beams to provide the services previously provided by the disabled cell.

18. The method of claim 17 comprising using the two base stations positioned in a substantially opposed relationship.

19. In a wireless communication system including a plurality of cells, each cell including a base station, a method of restoring services previously provided by an outage condition in one of the cells, the method comprising:
determining the outage condition of a down-cell;
examining capabilities of at least a set of neighboring cells of the down-cell;
selecting a subset of the set of neighboring cells in accordance with interference and coverage criteria;
using the selected subset of the set of neighboring cells to provide communication coverage for portions of the down-cell;
using a set of nearby cells to pick up a load from the selected subset of the set of neighboring cells; and
giving priority to at least a subset of communications from the down-cell.

20. The method of claim 19 comprising determining if the outage condition represents a catastrophic failure of a type indicating need for priority coverage of the down-cell.
